(19) United States
(12) Patent Application Publication
(10) Pub. No.: US 2026/0073369 A1
(43) Pub. Date: Mar. 12, 2026

(54) REAL-TIME ACCOUNT VERIFICATION

(71) Applicant: Moov Financial, Inc., Cedar Falls, IA (US)

(72) Inventors: Wade Arnold, Golden, CO (US); Joshua Sadler, Phoenix, AZ (US); Charles Sander, San Francisco, CA (US)

(21) Appl. No.: 18/827,653

(22) Filed: Sep. 6, 2024

(51) Int. Cl. G06Q 20/10

(52) U.S. Cl. CPC G06Q 20/108

(57) ABSTRACT

Systems and methods for verifying a bank account in near real-time are provided. In particular, a computing device may receive a request to initiate a verification of a bank account. The request includes a source account identifier and a destination account identifier of the bank account. The computing device may further determine if the bank account supports real-time payments (RTP) and verify the bank account in near real-time via a first verification process in response to determining that the bank account supports RTP.

### BACKGROUND

Transfer platforms enable users to transfer funds between accounts in various financial institutes. To do so, a user creates an account on a transfer platform and links a bank account to the transfer platform account to transfer funds on the transfer platform. Prior to transferring any funds, the transfer platform needs to verify the bank account to reduce the risk of fraud or unauthorized activity. Generally, a verification of a bank account cannot be completed in a single session or may require the users to provide their sensitive login credentials to access the bank account. For example, the transfer platform may utilize a micro-deposit verification for verifying bank account information using Automated Clearing House (ACH) payments. The micro-deposit verification process involves sending two small deposits to the bank account and a form to the user to enter the exact deposit amount into the form. However, this verification process may take at least one business day and up to 5 business days for those deposits to appear on the user's bank account as the transactions go through the ACH network. In some cases, the deposits can get easily lost and/or the user may not come back after initiating the verification process to complete the verification once the deposits appear on the user's bank account.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to an instant verification of a bank account of a user in near real-time by a transfer platform. In examples, a verification process may depend on whether the bank account supports real-time payments (RTP). RTP is a payment processing network for sending funds electronically between financial institutes. RTP transfers funds between two bank accounts instantaneously and thus enables instant funds transfer. Upon receiving a request to initiate a verification of a bank account, the transfer platform determines whether the bank account supports RTP (e.g., whether the bank account can receive RTP transfers). If the bank account supports RTP, the transfer platform may initiate a RTP microdeposit verification process to verify the bank account. To do so, the transfer platform initiates an RTP transaction by sending a credit transfer message with a predetermined value and a verification code in a plurality of remittance fields to the bank account. This causes the RTP transaction to be posted to the bank account in near real-time. Once the transfer platform receives an indication that the RTP transaction was successful, an input field is immediately presented on a user interface for accepting the verification code from the user. The bank account is successfully verified upon receiving the correct verification code that was sent to the bank account.

In accordance with at least one example of the present disclosure, a system for an account verification in near real-time is provided. The system may include a processor and a memory having a plurality of instructions stored thereon that, when executed by the processor, the system to perform a set of operations, the set of operations comprising receiving a request to initiate a verification of a bank account, the request including a source account identifier, a destination account identifier of the bank account, determining if the bank account supports real-time payments (RTP), and in response to determining that the bank account supports RTP, verifying the bank account in near real-time via a first verification process.

In accordance with at least one example of the present disclosure, a method for verifying a bank account in near real-time is provided. The method may include receiving a request to initiate a verification of a bank account, the request including a source account identifier, a destination account identifier of the bank account, determining if the bank account supports real-time payments (RTP), and in response to determining that the bank account supports RTP, verifying the bank account in near real-time via a first verification process.

In accordance with at least one example of the present disclosure, a non-transitory computer-readable medium storing computer-executable instructions for verifying a bank account in near real-time is provided. The instructions when executed cause at least one processor to perform operations, including, receiving a request to initiate a verification of a bank account, the request including a source account identifier, a destination account identifier of the bank account, determining if the bank account supports real-time payments (RTP), and in response to determining that the bank account supports RTP, verifying the bank account in near real-time via a first verification process.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which a transfer platform may group a series of transfers according to aspects described herein.

FIG. 2 illustrates an overview of an example method for processing a request to verify a bank account according to aspects described herein.

FIG. 3 illustrates an overview of an example method for processing a request to verify a bank account via a first verification process according to aspects described herein.

FIG. 4 illustrates an overview of an example method for processing a request to verify a bank account via a second verification process according to aspects described herein.

FIG. 5 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Transfer platforms enable users to transfer funds between accounts in various financial institutes. To do so, a user creates an account on a transfer platform and links a bank account to the transfer platform account to transfer funds on the transfer platform. Prior to transferring any funds, the transfer platform needs to verify the bank account to reduce the risk of fraud or unauthorized activity. Generally, a verification of a bank account cannot be completed in a single session or may require the users to provide their sensitive login credentials to access the bank account. For example, the transfer platform may utilize a micro-deposit verification for verifying bank account information using Automated Clearing House (ACH) payments. The micro-deposit verification process involves sending two small deposits to the bank account and a form to the user to enter the exact deposit amount into the form. However, this verification process may take at least one business day and up to 5 business days for those deposits to appear on the user's bank account as the transactions go through the ACH network. In some cases, the deposits can get easily lost and/or the user may not come back after initiating the verification process to complete the verification once the deposits appear on the user's bank account.

Accordingly, aspects of the present disclosure relate to an instant verification of a bank account of a user in near real-time by a transfer platform. In examples, a verification process may depend on whether the bank account supports real-time payments (RTP). RTP is a payment processing network for sending funds electronically between financial institutes. RTP transfers funds between two bank accounts instantaneously and thus enables instant funds transfer. Upon receiving a request to initiate a verification of a bank account, the transfer platform determines whether the bank account supports RTP (e.g., whether the bank account can receive RTP transfers). If the bank account supports RTP, the transfer platform may initiate a RTP microdeposit verification process to verify the bank account. To do so, the transfer platform initiates an RTP transaction by sending a credit transfer message with a predetermined value and a verification code in a plurality of remittance fields to the bank account. This causes the RTP transaction to be posted to the bank account in near real-time. Once the transfer platform receives an indication that the RTP transaction was successful, an input field is immediately presented on a user interface for accepting the verification code from the user. The bank account is successfully verified upon receiving the correct verification code that was sent to the bank account.

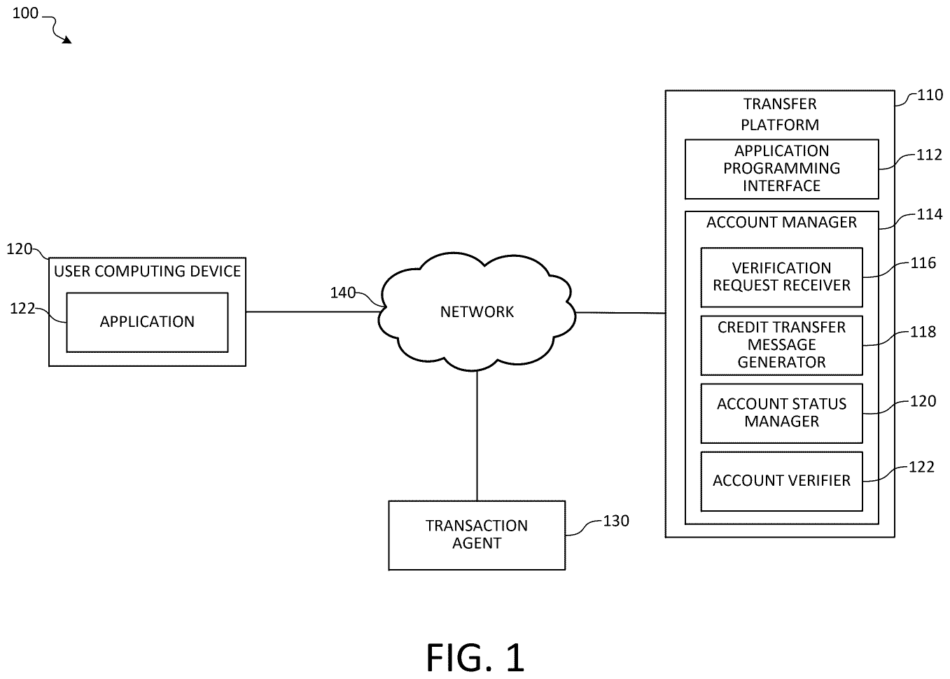

Referring now to FIG. 1, an overview of an example system 100 in which a transfer platform 110 may verify a bank account of a user according to aspects described herein. As illustrated, the system 100 comprises a transfer platform 110, a user computing device 120, a transaction agent 130, and a network 140. In examples, the transfer platform 110, the user computing device 120, and the transaction agent 130 communicate via network 140. For example, the network 140 may comprise a local area network, a wireless network, or the Internet, or any combination thereof, among other examples. The transfer platform 110, the user computing device 120, and the transaction agent 130 may each be any of a variety of computing devices, including, but not limited to, a mobile computing device, a laptop computing device, a tablet computing device, a desktop computing device, a server computing device, and/or a distributed computing device comprised of a set of computing devices that provide the functionality described herein. It will be appreciated that while system 100 is illustrated as comprising one transfer platform 110, one user computing device 120, and one transaction agent 130, any number of such elements may be used in other examples. Further, the functionality described herein may be distributed among or otherwise implemented on any number of different computing devices in any of a variety of other configurations in other examples.

As illustrated, the transfer platform 110 comprises an application programming interface 112 and an account manager 114. The account manager 114 further includes a verification request receiver 116, a credit transfer message generator 118, an account status manager 120, and an account verifier 122. In examples, application programming interface 112 is used to request or otherwise manage a transfer and/or to access information from the transfer platform 110 (e.g., relating to a transfer), among other examples. For example, an application 122 of user computing device 120 uses the application programming interface 112 to communicate with the transfer platform 110 according to aspects described herein. While the application programming interface 112 is illustrated separately from the account manager 114, it will be appreciated that the application programming interface 112 may be part of and/or may otherwise enable access to any of a variety of functionality of the account manager 114, the verification request receiver 116, the credit transfer message generator 118, the account status manager 120, and/or the account verifier 122.

Additionally, or alternatively, the account manager 114, the verification request receiver 116, the credit transfer message generator 118, the account status manager 120, and/or the account verifier 122 may use the application programming interface 112 to interface with any of a variety of other elements of transfer platform 110. As another example, an event bus may be used to pass events and/or messages between the verification request receiver 116, the credit transfer message generator 118, the account status manager 120, and/or the account verifier 122, among other examples.

In examples, the account manager 114 is configured to manage one or more accounts linked to each user of the transfer platform 110. For example, the account manager 114 is configured to verify and link bank accounts to a user's account on the transfer platform 110 and manage transfers between accounts.

The verification request receiver 116 is configured to receive a request (e.g., via application programming interface 112) for an account verification from a user according to aspects described herein. As noted above, the request may include an account identifier and a bank account identifier, where the account identifier is an identifier of the user's account on the transfer platform 110 and the bank account identifier is an identifier of the bank account to be linked to the user's account on the transfer platform 110. Upon receiving a request to initiate a verification of a bank account, the verification request receiver 116 is configured to determine whether the bank account supports real-time payments (RTP) (e.g., whether the bank account can receive RTP transfers). As described above, RTP is a payment processing network for sending funds electronically between financial institutes. RTP transfers funds between two bank accounts instantaneously and thus enables instant funds transfer.

The credit transfer message generator 118 is configured to generate a credit transfer message to initiate an account verification process. Specifically, the credit transfer message generator 118 is configured to generate respective different credit transfer messages depending on a designated verification process to be used to verify the bank account.

For example, if the bank account supports the RTP, the credit transfer message generator 118 is configured to generate a credit transfer message for an RTP transaction with the bank account (e.g., if the bank account supports the RTP) for initiating an RTP microdeposit verification process. In such embodiments, the credit transfer message is generated to include a predetermined value for a microdeposit and a verification code within a plurality of remittance fields. In examples, the predetermined value for the microdeposit is $0.01 and the verification code is a four-digit number, which is randomly generated for each RTP transaction and expires after a predetermined time period (e.g., 14 days) after the successful initiation of the RTP transaction. The credit transfer message is transmitted to the bank account to cause the RTP transaction to be posted to the bank account in near real-time.

If, however, the bank account does not support the RTP or otherwise not available, the credit transfer message generator 118 is configured to generate a credit transfer message for an ACH transaction with the bank account for initiating an ACH microdeposit verification process. In such embodiments, the credit transfer message is generated to include one or more predetermined values for the microdeposits. The one or more values are randomly generated for each ACH transaction. In other words, the one or more values of the microdeposits are used as unique codes to verify the bank account. For example, in some embodiments, the credit transfer message may include two credits of random amounts. In certain embodiments, similar to the RTP microdeposit verification described above, the credit transfer message may include a randomly generated value or code with a $0.01 deposit in lieu of two credits of random amounts. Additionally, the one or more values generated for the ACH transaction expire after a predetermined time period (e.g., 14 days) after the successful initiation of the ACH transaction. The credit transfer message is transmitted to the bank account to cause the ACH transaction to be posted to the bank account within a few business days (e.g., three business days). The predetermined values may appear in the bank account at different times.

The account status manager 120 is configured to update a status of the bank account. During the RTP verification process, the account status manager 120 is configured to update the bank account status of the bank account to a “pending” status once an indication of a successful RTP transaction initiation is received. If, however, a failure code is received in response to the RTP transaction, the account status manager 120 is configured to update the bank account status to “verification failed” or “errored” based on the failure code. Additionally, the account status manager 120 is configured to update the bank account status to a “verified” status if the correct verification code (e.g., the same as the verification code that was included in the RTP transaction) is received. However, if an incorrect code has been received more than a predetermined number of times, the account status manager 120 is configured to update the bank account status of the bank account to a “verification failed” status for exceeding a maximum number of attempts. If the correct verification code is not received in the input field within a predetermined time period (e.g., 14 days), the account status manager 120 is configured to update the bank account status of the bank account to the “verification failed” status for reaching the expiration of the verification code. Lastly, if the correct verification code is not received after 3 codes expire or have not been submitted correctly, the account status manager 120 is configured to update the bank account status of the bank account to an “errored”status for reaching the maximum verification failures.

During the ACH verification process, the account status manager 120 is configured to update the bank account status of the bank account to a “pending” status once an indication of a successful ACH transaction initiation is received. If, however, a return code is received in response to the ACH transaction, the account status manager 120 is configured to update the bank account status to “verification failed” or “errored” based on the return code. Additionally, the account status manager 120 is configured to update the bank account status to a “verified” status if the correct values (e.g., the same as the one or more predetermined values of the microdeposits that were included in the ACH transaction) is received. However, if an incorrect value has been received more than a predetermined number of times, the account status manager 120 is configured to update the bank account status of the bank account to a “verification failed” status for exceeding a maximum number of attempts. If the correct values are not received within a predetermined time period (e.g., 14 days), the account status manager 120 is configured to update the bank account status of the bank account to the “verification failed” status for reaching the expiration of the one or more predetermined values for the microdeposits. Lastly, if the correct values are not received after 3 predetermined microdeposit values expire or have not been submitted correctly, the account status manager 120 is configured to update the bank account status of the bank account to an “errored”status for reaching the maximum verification failures.

The account verifier 122 is configured to verify the bank account upon receiving the correct verification code for the RTP verification or the correct microdeposit values for the ACH verification. Upon verification of the bank account, the account verifier 122 is configured to link the bank account to the transfer platform account of the transfer platform to allow the user of the bank account to participate in transfers from linked accounts on the transfer platform.

The transaction agent 130 is configured to transfer a resource for a transfer managed by transfer platform 110. For example, the transaction agent 130 is configured to perform an RTP transaction and/or an ACH transaction with bank accounts for account verification. Example transaction agents include, but are not limited to, a payment platform, a payment network, or a payment processor. For instance, transaction agent 130 may include a real-time payments (RTP) network, an automated clearing house (ACH) network, and/or a credit card network, among other examples. As noted above, any number of transaction agents may be used, each of which may have an associated set of attributes.

System 100 is also illustrated as comprising user computing device 120. As noted above, application 122 of user computing device 120 may be used to communicate with transfer platform 110 (e.g., via application programming interface 112). While examples are described with respect to application programming interface 112, it will be appreciated that a web browser may additionally or alternatively be used in other examples. Additionally, while user computing device 120 is described as communicating with transfer platform 110 in the instant example, it will be appreciated that, in another example, a third-party service (not pictured) may additionally or alternatively communicate with transfer platform 110. For instance, the third-party service provides a website accessed by user computing device 120 (e.g., via application 122), and further communicates with transfer platform 110 (e.g., via application programming interface 112) to provide associated functionality of the website.

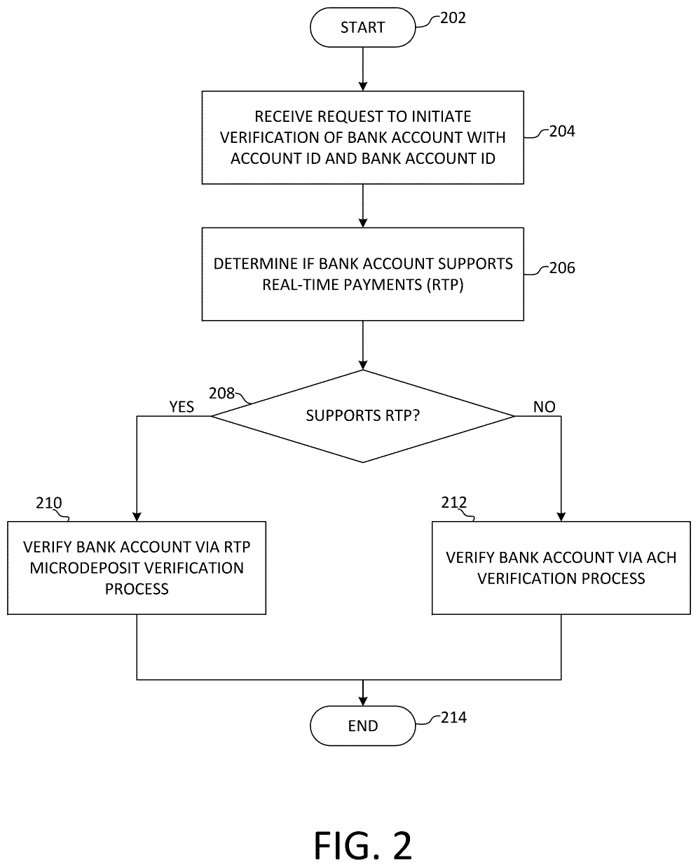

FIG. 2 illustrates an overview of an example method 200 for verifying a bank account according to aspects described herein. A general order for the steps of the method 200 is shown in FIG. 2. Generally, the method 200 starts at 202 and ends at 214. The method 200 may include more or fewer steps or may arrange the order of the steps differently than those shown in FIG. 2. In the illustrative aspect, aspects of method 200 are performed by a transfer platform, such as the transfer platform 110 in FIG. 1.

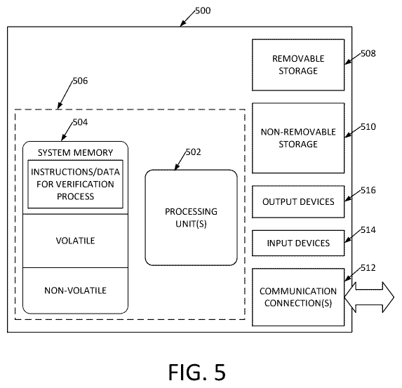

The method 200 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), a Neural Processing Unit (NPU), or other hardware device. Hereinafter, the method 200 shall be explained with reference to the systems, components, modules, software, data structures, user interfaces, etc. described in conjunction with FIGS. 1 and 5.

As illustrated, the method 200 begins at operation 202, where flow may proceed to 204. At operation 204, the transfer platform 110 receives a request to initiate a verification of a bank account of a user. For example, the request includes an account identifier and a bank account identifier, where the account identifier is an identifier of the user's account on the transfer platform 110 and the bank account identifier is an identifier of the bank account to be linked to the user's account on the transfer platform 110.

At operation 206, upon receiving a request to initiate a verification of a bank account, the transfer platform 110 determines whether the bank account supports real-time payments (RTP) (e.g., whether the bank account can receive RTP transfers). As described above, RTP is a payment processing network for sending funds electronically between financial institutes. RTP transfers funds between two bank accounts instantaneously and thus enables instant funds transfer.

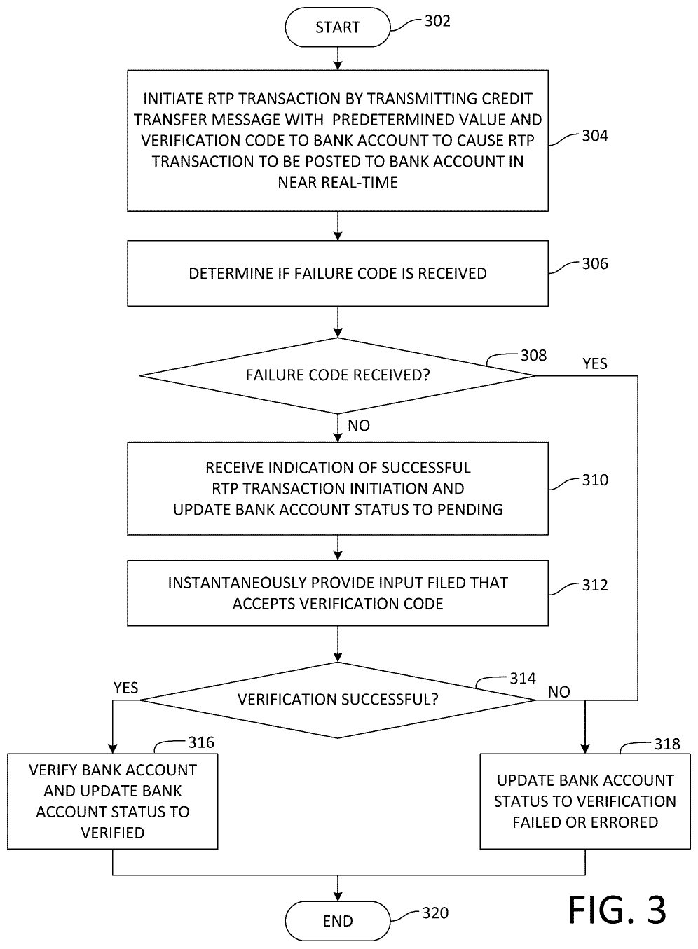

If the transfer platform 110 determines that the bank account supports RTP at operation 208, the method 200 proceeds to operation 210. At operation 210, the transfer platform 110 initiates the verification of the bank account via an RTP microdeposit verification process, which is further described in FIG. 3. Subsequently, the method 200 may end at operation 214.

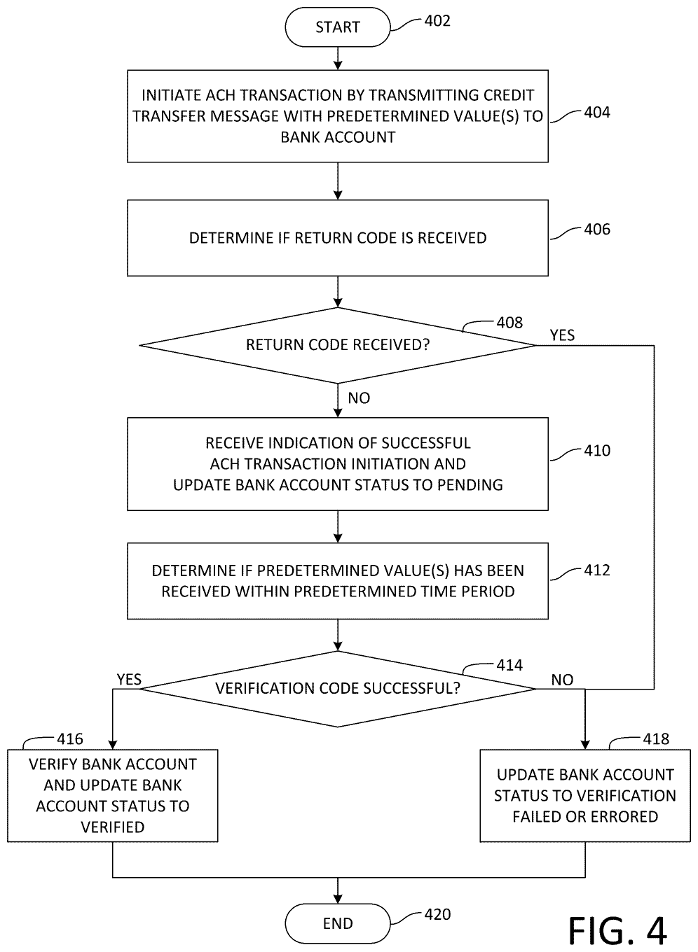

If, however, the transfer platform 110 determines that RTP is not supported by the bank account at operation 208, the method 200 proceeds to operation 212. At operation 212, the transfer platform 110 initiates the verification of the bank account via an ACH verification process, which is further described in FIG. 4. Subsequently, the method 200 may end at operation 214.

Referring now to FIG. 3, an overview of an example method 300 for verifying a bank account in near real-time via an RTP microdeposit verification process in accordance with examples of the present disclosure is provided. A general order for the steps of the method 300 is shown in FIG. 3. Generally, the method 300 starts at 302 and ends at 320. The method 300 may include more or fewer steps or may arrange the order of the steps differently than those shown in FIG. 3. In the illustrative aspect, aspects of method 300 are performed by a transfer platform, such as the transfer platform 110 in FIG. 1.

The method 300 can be executed as a set of computer-executable instructions executed by a computer system and encoded or stored on a computer readable medium. Further, the method 300 can be performed by gates or circuits associated with a processor, Application Specific Integrated Circuit (ASIC), a field programmable gate array (FPGA), a system on chip (SOC), a Neural Processing Unit (NPU), or other hardware device. Hereinafter, the method 300 shall be explained with reference to the systems, components, modules, software, data structures, user interfaces, etc. described in conjunction with FIGS. 1 and 5.

As illustrated, the method 300 begins at operation 302, where flow may proceed to 304 to initiate the real-time payments (RTP) microdeposit verification process. As described above, the transfer platform 110 may verify a bank account via the RTP microdeposit verification process if the bank account supports RTP. However, it should be appreciated that, in some embodiments, the transfer platform 110 may provide an option for the user to choose between the RTP microdeposit verification process and an ACH verification process to verify the bank account. The transfer platform 110 may further provide explanations that the RTP microdeposit verification process provides an instant verification while the ACH verification process may take longer (e.g., up to 5 business days) to complete. In such embodiments, if the RTP microdeposit verification process is selected, the method 300 proceeds to operation 304. If, however, the ACH verification process is selected, the transfer platform 110 initiates the account verification via the ACH verification process described in FIG. 4.

At operation 304, the transfer platform 110 initiates an RTP transaction with the bank account. To do so, the transfer platform 110 generates a credit transfer message with a predetermined value for a microdeposit and a verification code within a plurality of remittance fields. In examples, the predetermined value for the microdeposit is $0.01 and the verification code is a randomly generated four-digit number. The transfer platform 110 transmits the credit transfer message to the bank account to cause the RTP transaction to be posted to the bank account in near real-time. In examples, the verification code expires after a predetermined time period (e.g., 14 days). In some embodiments, once the RTP transaction is initiated, the transfer platform 110 may simultaneously initiate a debit to recoup the microdeposit from the bank account.

At operation 306, the transfer platform 110 determines if a failure code has been received in response to the RTP transaction. If the failure code has been received, the method 300 skips ahead to operation 318 to update a bank account status of the bank account to “verification failed” or “errored”based on the failure code.

If, however, the failure code has not been received at operation 308, the method 300 advances to operation 310 to receive an indication of a successful RTP transaction initiation and update the bank account status of the bank account to “pending”. Once the indication of the successful RTP transaction initiation is received, the transfer platform 110 instantaneously provide an input field that accepts the verification. In examples, the input field is presented on a graphical user interface to allow the user to enter the verification code that was sent to the bank account.

At operation 314, the transfer platform 110 determines whether the verification of the bank account was successful. For example, the transfer platform 110 determines if the user entered a code in the input field. If so, the transfer platform 110 further determines if the code the user entered is correct (e.g., the same as the verification code that was included in the RTP transaction to the bank account). If the transfer platform 110 determines that the user entered the correct verification code, the method 300 advances to operation 316 to indicate that the bank account has been verified and update the bank account status to a “verified” status. Subsequently, the method 300 may end at operation 320.

In some examples, a code may be received in the input field but may be incorrect. If the transfer platform 110 determines that an incorrect code has been received more than a predetermined number of times at operation 314, the method 300 advances to operation 316 to update the bank account status of the bank account to a “verification failed” status for exceeding a maximum number of attempts.

Additionally, if the correct verification code is not received in the input field within a predetermined time period (e.g., 14 days), the method 300 advances to operation 316 to update the bank account status of the bank account to the “verification failed” status for reaching the expiration of the verification code. In such embodiments, the method 300 may loop back to operation 304 to transmit a subsequent RTP transaction with a new verification code. If the correct verification code is not received after 3 codes expire or have not been submitted correctly, the transfer platform 110 updates the bank account status of the bank account to an “errored” status for reaching the maximum verification failures. Subsequently, the method 300 may end at operation 320.

Referring now to FIG. 4, an overview of an example method 400 for verifying a bank account via an ACH verification process in accordance with examples of the present disclosure is provided. A general order for the steps of the method 400 is shown in FIG. 4. Generally, the method 400 starts at 402 and ends at 420. The method 400 may include more or fewer steps or may arrange the order of the steps differently than those shown in FIG. 4. In the illustrative aspect, aspects of method 400 are performed by a transfer platform, such as the transfer platform 110 in FIG. 1.

The method 400 can be executed as a set of computer-executable instructions executed by a computer system and encoded or stored on a computer readable medium. Further, the method 400 can be performed by gates or circuits associated with a processor, Application Specific Integrated Circuit (ASIC), a field programmable gate array (FPGA), a system on chip (SOC), a Neural Processing Unit (NPU), or other hardware device. Hereinafter, the method 400 shall be explained with reference to the systems, components, modules, software, data structures, user interfaces, etc. described in conjunction with FIGS. 1 and 5.

As illustrated, the method 400 begins at operation 402, where flow may proceed to 404 to initiate the Automated Clearing House (ACH) microdeposit verification process. As described above, the transfer platform 110 may verify a bank account via the ACH verification process if the bank account does not support RTP. However, in some embodiments, the user may choose to proceed with the ACH microdeposit verification even if the bank account supports RTP.

At operation 404, the transfer platform 110 initiates an ACH transaction with the bank account. To do so, the transfer platform 110 generates a credit transfer message with one or more predetermined values for the microdeposits. The one or more predetermined values are randomly generated for each ACH transaction. In other words, the one or more predetermined values of the microdeposits are used as unique codes to verify the bank account. Additionally, the one or more values generated for the ACH transaction expire after a predetermined time period (e.g., 14 days) after the successful initiation of the ACH transaction. In examples, the transfer platform 110 may generate two predetermined values for microdeposits, each microdeposit value may be up to $ 0.49. However, in some embodiments, the transfer platform 110 may generate a single randomly generated value or code to be sent with a predetermined microdeposit amount (e.g., $0.01 microdeposit) in lieu of two predetermined values. The transfer platform 110 transmits the credit transfer message to the bank account to cause the ACH transaction to be posted to the bank account within a few business days (e.g., three business days). The predetermined values may appear in the bank account at different times. It should be appreciated that, once the ACH transaction is initiated, the transfer platform 110 simultaneously initiates a debit to recoup the microdeposits from the bank account.

At operation 406, the transfer platform 110 determines if a return code has been received in response to the ACH transaction. If the return code has been received, the method 400 skips ahead to operation 418 to update a bank account status of the bank account to “verification failed” or “errored”based on the return code.

If, however, the return code has not been received at operation 408, the method 400 advances to operation 410 to receive an indication of a successful ACH transaction initiation and update the bank account status of the bank account to “pending”.

At operation 412, once the indication of the successful ACH transaction initiation is received, the transfer platform 110 determines if the one or more predetermined values have been received within the predetermined time period. As described above, the predetermined values may appear in the bank account at different times. Once the user sees the predetermined values in the bank account, the user needs to access a link or page through the application programming interface (API) 112 of the transfer platform 110 to enter the one or more predetermined values in an input field for verifying the bank account.

At operation 414, the transfer platform 110 determines whether the verification of the bank account was successful. For example, the transfer platform 110 determines if the user entered one or more values in the input field. If so, the transfer platform 110 further determines if the values the user entered is correct (e.g., the same as the one or more predetermined values of the microdeposits that were sent to the bank account). If the transfer platform 110 determines that the user entered the correct values, the method 400 advances to operation 416 to indicate that the bank account has been verified and update the bank account status to a “verified” status. Subsequently, the method 400 may end at operation 420.

In some examples, some values may be received in the input field but may be incorrect. If the transfer platform 110 determines that incorrect values have been received more than a predetermined number of times at operation 414, the method 400 advances to operation 416 to update the bank account status of the bank account to a “verification failed” status for exceeding a maximum number of attempts.

Additionally, if the correct predetermined values are not received in the input field within a predetermined time period (e.g., 14 days), the method 400 advances to operation 416 to update the bank account status of the bank account to the “verification failed” status for reaching the expiration of the predetermined values of the microdeposits. In such embodiments, the method 400 may loop back to operation 404 to transmit a subsequent ACH transaction with microdeposits with new predetermined values. If the correct predetermined values are not received after 3 predetermined values expire or have not been submitted correctly, the transfer platform 110 updates the bank account status of the bank account to an “errored” status for reaching the maximum verification failures. Subsequently, the method 300 may end at operation 320.

FIG. 5 illustrates an example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically may include at least one processing unit 502 and memory 504. Depending on the exact configuration and type of computing device, memory 504 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 may include at least some form of computer readable media. The computer readable media may be any available media that can be accessed by processing unit 502 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein such as the methods illustrated in FIGS. 2, 3A, 3B, 4, or 5, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

In accordance with at least one example of the present disclosure, a system for an account verification in near real-time is provided. The system may include a processor and a memory having a plurality of instructions stored thereon that, when executed by the processor, the system to perform a set of operations, the set of operations comprising receiving a request to initiate a verification of a bank account, the request including a source account identifier, a destination account identifier of the bank account, determining if the bank account supports real-time payments (RTP), and in response to determining that the bank account supports RTP, verifying the bank account in near real-time via a first verification process.

In accordance with at least one aspect of the above system, the system may include the set of operation where verifying the bank account via the first verification process may further include initiating an RTP transaction by transmitting a credit transfer message to the bank account to cause the RTP transaction to be posted to the bank account in near real-time, the credit transfer message including a plurality of remittance fields indicative of a predetermined value and a verification code, in response to receiving an indication of successful RTP transaction initiation, updating a bank account status associated with the bank account to pending and providing an input field on a user interface for accepting the verification code, and in response to receiving the verification code, verifying the bank account and updating the bank account status to verified.

In accordance with at least one aspect of the above system, the system may include the set of operation where transmitting the credit transfer message to the bank account may include dynamically determining which field of the plurality of remittance fields to include the verification code based on the destination account identifier of the bank account.

In accordance with at least one aspect of the above system, the system may include the set of operation where the plurality of remittance fields includes an account number field for the destination account identifier of the bank account, a financial institute identifier field for a financial institute associated with the bank account, a name field, and/or a memo field.

In accordance with at least one aspect of the above system, the system may include the set of operation where the verification code is a randomly generated four-digit code.

In accordance with at least one aspect of the above system, the set of operation may further include in response to receiving a failure code subsequent to the RTP transaction, updating a bank account status to verification failed or errored based on the failure code.

In accordance with at least one aspect of the above system, the set of operation may further include in response to not receiving verification code for a predetermined time period, updating the bank account status to verification failed.

In accordance with at least one aspect of the above system, the set of operation may further include in response to receiving an incorrect verification code for a first predetermined number of times, updating the bank account status to verification failed.

In accordance with at least one aspect of the above system, the set of operation may further include in response to initiating RTP transactions for a second predetermined number of times and continuing to receive an incorrect verification code for the first predetermined number of times, updating the bank account status to errored for reaching maximum verification transactions.

In accordance with at least one aspect of the above system, the set of operation may further include in response to determining that the bank account does not support RTP, verifying the bank account via a second verification process.

In accordance with at least one aspect of the above system, the system may include the set of operation where verifying the bank account via the second verification process may further include initiating an Automated Clearing House (ACH) transaction by transmitting a credit transfer message to the bank account to cause the ACH transaction to be posted to the bank account, the credit transfer message including a plurality of remittance fields indicative of one or more predetermined values, in response to receiving an indication of successful ACH transaction initiation, updating a bank account status associated with the bank account to pending, determining if the one or more predetermined values have been received within a predetermined time period, and in response to receiving the one or more predetermined values, verifying the bank account and updating the bank account status to verified.

In accordance with at least one example of the present disclosure, a method for verifying a bank account in near real-time is provided. The method may include receiving a request to initiate a verification of a bank account, the request including a source account identifier, a destination account identifier of the bank account, determining if the bank account supports real-time payments (RTP), and in response to determining that the bank account supports RTP, verifying the bank account in near real-time via a first verification process.

In accordance with at least one aspect of the above method, the method may include where verifying the bank account via the first verification process comprises initiating an RTP transaction by transmitting a credit transfer message to the bank account to cause the RTP transaction to be posted to the bank account in near real-time, the credit transfer message including a plurality of remittance fields indicative of a predetermined value and a verification code, in response to receiving an indication of successful RTP transaction initiation, updating a bank account status associated with the bank account to pending and providing an input field on a user interface for accepting the verification code, and in response to receiving the verification code, verifying the bank account and updating the bank account status to verified.

In accordance with at least one aspect of the above method, the method may include where transmitting the credit transfer message to the bank account comprises dynamically determining which field of the plurality of remittance fields to include the verification code based on the destination account identifier of the bank account.

In accordance with at least one aspect of the above method, the method may include where the plurality of remittance fields includes an account number field for the destination account identifier of the bank account, a financial institute identifier field for a financial institute associated with the bank account, a name field, and/or a memo field, and wherein the verification code is a randomly generated four-digit code.

In accordance with at least one aspect of the above method, the method may include in response to determining that the bank account does not support RTP, verifying the bank account via a second verification process. In accordance with at least one aspect of the above method, the method may include where verifying the bank account via the second verification process comprises initiating an Automated Clearing House (ACH) transaction by transmitting a credit transfer message to the bank account to cause the ACH transaction to be posted to the bank account, the credit transfer message including a plurality of remittance fields indicative of one or more predetermined values, in response to receiving an indication of successful ACH transaction initiation, updating a bank account status associated with the bank account to pending, determining if the one or more predetermined values have been received within a predetermined time period, and in response to receiving the one or more predetermined values, verifying the bank account and updating the bank account status to verified.

In accordance with at least one example of the present disclosure, a non-transitory computer-readable medium storing computer-executable instructions for verifying a bank account in near real-time is provided. The instructions when executed cause at least one processor to perform operations, including, receiving a request to initiate a verification of a bank account, the request including a source account identifier, a destination account identifier of the bank account, determining if the bank account supports real-time payments (RTP), and in response to determining that the bank account supports RTP, verifying the bank account in near real-time via a first verification process.

In accordance with at least one aspect of the above non-transitory computer-readable medium, the operations may further include where verifying the bank account via the first verification process comprises initiating an RTP transaction by transmitting a credit transfer message to the bank account to cause the RTP transaction to be posted to the bank account in near real-time, the credit transfer message including a plurality of remittance fields indicative of a predetermined value and a verification code, in response to receiving an indication of successful RTP transaction initiation, updating a bank account status associated with the bank account to pending and providing an input field on a user interface for accepting the verification code, and in response to receiving the verification code, verifying the bank account and updating the bank account status to verified.

In accordance with at least one aspect of the above non-transitory computer-readable medium, the operations may further include where transmitting the credit transfer message to the bank account comprises dynamically determining which field of the plurality of remittance fields to include the verification code based on the destination account identifier of the bank account.

In accordance with at least one aspect of the above non-transitory computer-readable medium, the operations may further include where the plurality of remittance fields includes an account number field for the destination account identifier of the bank account, a financial institute identifier field for a financial institute associated with the bank account, a name field, and/or a memo field, and wherein the verification code is a randomly generated four-digit code.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system for an account verification in near real-time, the system comprising:
at least one processor; and
memory storing instructions that, when executed by the at least one processor, causes the system to perform a set of operations, the set of operations comprising:
receiving a request to initiate a verification of a bank account, the request including a source account identifier, a destination account identifier of the bank account;
determining if the bank account supports real-time payments (RTP); and
in response to determining that the bank account supports RTP, verifying the bank account in near real-time via a first verification process.

2. The system of claim 1, wherein verifying the bank account via the first verification process comprises:
initiating an RTP transaction by transmitting a credit transfer message to the bank account to cause the RTP transaction to be posted to the bank account in near real-time, the credit transfer message including a plurality of remittance fields indicative of a predetermined value and a verification code;
in response to receiving an indication of successful RTP transaction initiation, updating a bank account status associated with the bank account to pending and providing an input field on a user interface for accepting the verification code; and
in response to receiving the verification code, verifying the bank account and updating the bank account status to verified.

3. The system of claim 2, wherein transmitting the credit transfer message to the bank account comprises:
dynamically determining which field of the plurality of remittance fields to include the verification code based on the destination account identifier of the bank account.

4. The system of claim 3, wherein the plurality of remittance fields includes an account number field for the destination account identifier of the bank account, a financial institute identifier field for a financial institute associated with the bank account, a name field, and/or a memo field.

5. The system of claim 1, wherein the verification code is a randomly generated four-digit code.

6. The system of claim 1, wherein the set of operations further comprises:
in response to receiving a failure code subsequent to the RTP transaction, updating a bank account status to verification failed or errored based on the failure code.

7. The system of claim 6, wherein the set of operations further comprises:
in response to not receiving verification code for a predetermined time period, updating the bank account status to verification failed.

8. The system of claim 2, wherein the set of operations further comprises:
in response to receiving an incorrect verification code for a first predetermined number of times, updating the bank account status to verification failed.

9. The system of claim 8, wherein the set of operations further comprises:
in response to initiating RTP transactions for a second predetermined number of times and continuing to receive an incorrect verification code for the first predetermined number of times, updating the bank account status to errored for reaching maximum verification transactions.

10. The system of claim 1, wherein the set of operations further comprises:
in response to determining that the bank account does not support RTP, verifying the bank account via a second verification process.

11. The system of claim 10, wherein verifying the bank account via the second verification process comprises:
initiating an Automated Clearing House (ACH) transaction by transmitting a credit transfer message to the bank account to cause the ACH transaction to be posted to the bank account, the credit transfer message including a plurality of remittance fields indicative of one or more predetermined values;
in response to receiving an indication of successful ACH transaction initiation, updating a bank account status associated with the bank account to pending;
determining if the one or more predetermined values have been received within a predetermined time period; and
in response to receiving the one or more predetermined values, verifying the bank account and updating the bank account status to verified.

12. A method of verifying a bank account in near real-time, comprising:
receiving a request to initiate a verification of a bank account, the request including a source account identifier, a destination account identifier of the bank account;
determining if the bank account supports real-time payments (RTP); and
in response to determining that the bank account supports RTP, verifying the bank account in near real-time via a first verification process.

13. The method of claim 12, wherein verifying the bank account via the first verification process comprises:
initiating an RTP transaction by transmitting a credit transfer message to the bank account to cause the RTP transaction to be posted to the bank account in near real-time, the credit transfer message including a plurality of remittance fields indicative of a predetermined value and a verification code;
in response to receiving an indication of successful RTP transaction initiation, updating a bank account status associated with the bank account to pending and providing an input field on a user interface for accepting the verification code; and
in response to receiving the verification code, verifying the bank account and updating the bank account status to verified.

14. The method of claim 13, wherein transmitting the credit transfer message to the bank account comprises:
dynamically determining which field of the plurality of remittance fields to include the verification code based on the destination account identifier of the bank account.

15. The method of claim 14, wherein the plurality of remittance fields includes an account number field for the destination account identifier of the bank account, a financial institute identifier field for a financial institute associated with the bank account, a name field, and/or a memo field, and wherein the verification code is a randomly generated four-digit code.

16. The method of claim 12, further comprising:
in response to determining that the bank account does not support RTP, verifying the bank account via a second verification process, wherein verifying the bank account via the second verification process comprises:
initiating an Automated Clearing House (ACH) transaction by transmitting a credit transfer message to the bank account to cause the ACH transaction to be posted to the bank account, the credit transfer message including a plurality of remittance fields indicative of one or more predetermined values;
in response to receiving an indication of successful ACH transaction initiation, updating a bank account status associated with the bank account to pending;
determining if the one or more predetermined values have been received within a predetermined time period; and
in response to receiving the one or more predetermined values, verifying the bank account and updating the bank account status to verified.

17. A non-transitory computer storage medium storing computer-executable instructions that when executed cause at least one processor to perform operations, comprising:
receiving a request to initiate a verification of a bank account, the request including a source account identifier, a destination account identifier of the bank account;
determining if the bank account supports real-time payments (RTP); and
in response to determining that the bank account supports RTP, verifying the bank account in near real-time via a first verification process.

18. The non-transitory computer storage medium of claim 17, wherein verifying the bank account via the first verification process comprises:
initiating an RTP transaction by transmitting a credit transfer message to the bank account to cause the RTP transaction to be posted to the bank account in near real-time, the credit transfer message including a plurality of remittance fields indicative of a predetermined value and a verification code;
in response to receiving an indication of successful RTP transaction initiation, updating a bank account status associated with the bank account to pending and providing an input field on a user interface for accepting the verification code; and
in response to receiving the verification code, verifying the bank account and updating the bank account status to verified.

19. The non-transitory computer storage medium of claim 18, wherein transmitting the credit transfer message to the bank account comprises:
dynamically determining which field of the plurality of remittance fields to include the verification code based on the destination account identifier of the bank account.

20. The non-transitory computer storage medium of claim 19, wherein the plurality of remittance fields includes an account number field for the destination account identifier of the bank account, a financial institute identifier field for a financial institute associated with the bank account, a name field, and/or a memo field, and wherein the verification code is a randomly generated four-digit code.
